(19) United States
(12) Patent Application Publication
(10) Pub. No.: US 2007/0169618 A1
(43) Pub. Date: Jul. 26, 2007

(54) Hydraulic drive

(76) Inventor: Stefan Scheller, Riedenberg (DE)

Correspondence Address: KENYON & KENYON LLP, ONE BROADWAY, NEW YORK, NY, 10004, US

(21) Appl. No.: 11/591,983

(22) Filed: Nov. 1, 2006

(30) Foreign Application Priority Data
Nov. 4, 2005 (DE) 10 2005 053 106.7

(51) Int. Cl. F15B 13/16

(52) U.S. Cl. 91/358 R

(57) ABSTRACT

A hydraulic drive including a hydraulic motor, a position sensor, which allows for the detection of an actual value of a position of the hydraulic motor, a valve, which allows for a pressure medium path between the motor and a pressure medium source to be controlled, and a control electronics, which can be supplied with a position setpoint value signal and the actual value of the position of the motor and which allows for the valve to be triggered by an actuating signal in the sense of controlling the position of the motor. An event occurring prior to the hydraulic motor having reached a specified position is detected, and the actuating signal is limited as a function of the detection of this event.

### FIELD OF THE INVENTION

The present invention relates to a hydraulic drive which includes a control electronics for a position control.

### BACKGROUND INFORMATION

Hydraulic drives having a position control are used, e.g., in punching machines or nibbling machines for operating the cutting tool. German Patent No. DE 44 28 691 A1 describes such a hydraulic drive for a punching machine or a nibbling machine. A hydraulic cylinder operates a punching tool, which can be used to machine a workpiece. The actual position of the piston of the hydraulic cylinder is detected by a displacement sensor and is supplied to a control electronics. Using an actuating signal, the control electronics triggers a valve, which connects the hydraulic cylinder to a pressure medium source or a tank port. In this manner, the cylinder piston is moved in accordance with a setpoint specification. Normally, the cylinder piston is oscillated back and forth between an upper and a lower reversal point in order to perform punch machining. In order to reduce the noise generation when breaking off the punched material, German Patent No. DE 44 28 691 A1 describes that the pressure applied to the hydraulic cylinder is detected and a derivation of the pressure signal is formed. The derived pressure signal is superimposed on the actuating signal in such a way that it acts in the sense of separating the hydraulic cylinder from the pressure medium source when the punched material is broken off, i.e., when the pressure drops.

In punching and nibbling applications, the lower reversal point is usually specified to be barely, e.g., 1 mm below the lower surface of the workpiece facing away from the tool. When approaching this reversal point, the valve receives a closing signal from the control electronics. When the punched material breaks off, the hydraulic piston and thus the punching or nibbling tool undergoes a high acceleration on account of the effect of the expanding hydraulic oil and the expanding machine structure. Thus, from the breaking off of the punched material, the remaining distance to the reversal point is traveled very quickly. Under these circumstances, due to its time response, the position control loop in conventional hydraulic drives is not able to prevent the tool from clearly overshooting the reversal point. This increases the travel times and consequently the machining times for each workpiece. Moreover, in the event of a considerable overshooting, the workpiece or the tool may be damaged.

It would be desirable to be able reliably to approach a specified position setpoint value without or with only a minimal overshooting movement even under the influence of significant disturbance variables such as, e.g., a counteracting force that suddenly breaks off.

### SUMMARY

An example hydraulic drive according to the present invention comprises a hydraulic motor, a position sensor, which allows for the detection of an actual value of a position of the hydraulic motor, a valve, which allows for a pressure medium path between the motor and a pressure medium source to be controlled, and a control electronics, which is capable of being supplied with a position setpoint value signal and the actual value of the position of the motor and which allows for the valve to be triggered by an actuating signal in the sense of controlling the position of the motor. In accordance with an example embodiment of the present invention, an event which occurs prior to the hydraulic motor reaching a specified position is detected, and the actuating signal is limited as a function of the detection of this event.

In highly dynamic hydraulic drives, the valve is a large component of the time delay occurring in the control loop. If starting from a large opening cross-section, e.g., the control piston of the valve is to be moved into a closing position, then undesirably high control delays may occur. The distance which the valve piston must cover in order to close may be limited by limiting the actuating signal supplied to the valve in accordance with the present invention based on an event prior to reaching a specified setpoint position. Thus, the time delay in stopping the movement of the hydraulic motor caused by the valve is also limited to a low value. Consequently, the time constant of the control loop is reduced in approaching the specified position. When this position is approached, the control loop thus behaves in a particularly dynamic manner. This ensures a precise approach of the specified position even when significant disturbance variables act on the hydraulic drive. Overshooting reactions are significantly reduced.

According to a particularly preferred further development of the present invention, a pressure sensor is provided by which a pressure of the pressure medium applied to the motor may be measured. The actuating signal is limited as a function of the measured pressure. In particular in punching and nibbling machines or in all drives, in which a mechanical resistance must be overcome before reaching a specified setpoint position, this represents a particularly efficient possibility for detecting the approach to the specified position already a specific time prior to reaching the specified position and for influencing the control loop in the sense of decreasing the time constant of the actuator, that is, of the valve. Thus, particularly in the case of nibbling machines, on the one hand a large valve opening may be permitted during the unloaded actuating movement while on the other hand utilizing the advantages of a small valve opening that is quick to close from the moment that the tool touches down on a workpiece.

For this purpose, the control electronics preferably comprises a comparator circuit, which compares the measured pressure with a specified pressure threshold value.

The actuating signal is then limited if the measured pressure exceeds the pressure threshold value. Such a behavior can be implemented in a particularly simple manner using the control electronics. This additionally prevents the limitation of the valve opening from being activated by pressure fluctuations which are not caused by the contact with a workpiece, but which are due to other effects, e.g., acceleration processes, pulsations etc. of the hydraulic system.

Another preferred development provides for an event to be detected by a force sensor prior to reaching the specified position, which force sensor detects a force acting on the motor or a force exerted by the motor on a machine element. For this purpose, e.g., a strain gage or a load bolt on a workpiece table may be used. Alternatively, an electrical switching element e.g., a touch-sensitive switch, which registers the impingement of a tool on a sheet metal, a light barrier etc., may be provided for this purpose. On the basis of the displacement signal it is also possible to determine the approach of the specified position and to limit the actuating signal when a certain distance to the specified position is undershot. In punching or nibbling machines, this distance would be adjusted to the thickness of the sheet metal to be punched. Thus, it is possible in turn to permit a large valve opening during the unloaded actuating movement and achieve a small valve opening that can be closed quickly when the tool touches down on the sheet metal.

The aforementioned measures for detecting an event occurring prior to reaching a specified position may, of course, also be combined with one another so as to ensure a high reliability in the detection. It is also possible to detect various events occurring prior to reaching the specified position and to perform the limitation of the actuating signal as a function of multiple events.

The control electronics preferably comprises a signal limiter, by which the actuating signal supplied to the valve may be limited to a value that corresponds to a valve opening of less than 20% of a maximum valve opening. From an appropriate position, the valve piston is quickly adjustable to a closing position, particularly if a valve having a very steep opening characteristic is used in the region of a small opening.

Another particularly preferred refinement of the present invention is characterized in that the motor takes the form of a hydraulic cylinder, that the hydraulic cylinder is capable of operating a cutting tool and that the limitation of the actuating signal is triggered by the cutting tool contacting a workpiece prior to breaking through the workpiece. This refinement allows for the use of the hydraulic drive according to the present invention in cutting machines, e.g., nibbling machines, in which there are strict requirements with respect to an overshooting in the lower reversal point of the movement of the cutting tool. According to the present invention, the control loop is influenced in the sense of decreasing its mechanically determined time constant starting at the moment when the tool touches down on a workpiece. This, to the greatest extent possible, prevents overshooting events following the breaking off of the workpiece. In addition, unloaded actuation movements of the hydraulic cylinder may be performed at high speed.

The present invention and its advantages are described in greater detail below with reference to the exemplary embodiment shown in the figure.

### BRIEF DESCRIPTION OF THE DRAWING

FIG. 1 shows a circuit diagram of a hydraulic drive having a control loop, which is made up of a hydraulic cylinder or its piston, a displacement sensor, which measures the position of the piston, a valve, and a control electronics, which specifies a control value for the valve. Using a limiter, it is possible additionally to influence an actuating signal supplied to the valve.

### DETAILED DESCRIPTION OF EXAMPLE EMBODIMENTS

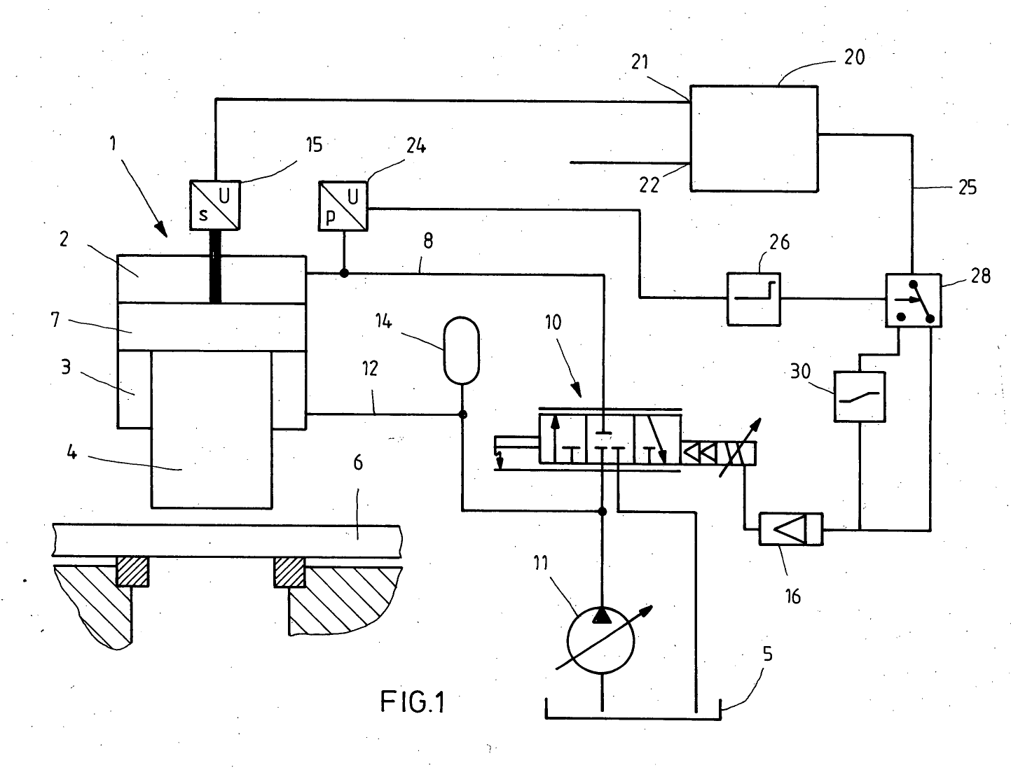

As shown in FIG. 1, a hydraulic drive has a differential cylinder 1 having a piston 7 situated in it in a movable manner and having a piston rod 4 capable of being shifted by piston 7. Piston 7 divides hydraulic cylinder 1 into a pressure chamber 3 on the side of the piston rod and a pressure chamber 2 on the side opposite of the piston rod. Piston rod 4 has attached to it a cutting tool (not shown) with the aid of which a workpiece 6 is cut. Pressure chamber 3 on the side of the piston rod is connected to a hydraulic pump 11 and a accumulator 14 via line 12. Pressure chamber 2 on the side opposite of the piston rod is connected to a valve 10 via line 8. Using its valve piston, the valve controls the connection of pressure chamber 2 to either the pressure medium source, i.e., hydraulic pump 11 and accumulator 14, or to a reservoir 5.

Valve 10 is triggered via a valve controller 16. Valve controller 16 triggers an actuating magnet of valve 10 using a specific current. Valve controller 16 receives an actuating signal regarding the deflection of the valve piston and triggers the actuating magnet in such a way that the valve piston assumes the respective position.

The position of piston 7 of differential cylinder 1 is detected by displacement sensor 15 and supplied as an actual signal to a control electronics 20 at an input 21. Control electronics 20 has another input 22, at which it is supplied with a setpoint signal for the position of piston 7. From these signals, control electronics 20 generates an actuating signal 25 in order to trigger valve 10. The pressure existing in pressure chamber 2 of differential cylinder 1 located on the side opposite of the piston rod is detected by pressure sensor 24 and supplied to a threshold stage 26. The output signal of threshold stage 26 triggers a signal switch 28. Actuating signal 25 of control electronics 20 is supplied by signal switch 28 either directly to valve controller 16 or is first transferred to a signal limiter 30. The output signal of signal limiter 30 in turn is supplied to valve controller 16.

The mode of operation of the hydraulic drive shown in FIG. 1 is explained in the following. Valve 10, displacement sensor 15 and control electronics 20 form a position control loop with respect to the position of piston 7 of differential cylinder 1. In the case of a nibbling machine or punching machine, alternately a lower and an upper reversal point of the nibbling movement is specified as a setpoint value on setpoint input 22 of the control electronics. The lower reversal point lies just below the lower surface of the workpiece facing away from the tool. As a function of the setpoint value and the actual position of piston 7, the control electronics generates an actuating signal 25 for triggering valve 10. Valve 10, by the way, together with its valve controller 16 represents a subordinate position control loop with respect to the position of the valve piston.

Pressure sensor 24 detects the pressure applied to pressure chamber 2. This pressure signal is supplied to threshold stage 26. Threshold stage 26 emits a signal in the event that the pressure signal exceeds a specified threshold value. In this case, signal switch 28 switches from the switching position shown in FIG. 1, in which it supplies actuating signal 25 directly to valve controller 16, into a switching position, in which it supplies actuating signal 25 to limiter 30. The limited switching signal is supplied to valve controller 16.

When a force appears that runs counter to the downward movement of piston 7, then the pressure rises in pressure chamber 2. This is the case when the tool of a nibbling machine touches down on a workpiece. At this time, valve 10 is still opened relatively wide since there is a deviation between the setpoint position of the tool, which corresponds to the lower reversal point, and the current position of the tool on the upper workpiece surface facing differential cylinder 1. The supply of pressurized medium further increases the pressure in pressure chamber 2 until the material of the workpiece finally breaks off. When a specified pressure is reached, prior to a breaking off of the workpiece material, the threshold stage emits a signal by which signal switch 28 is triggered in such a way that actuating signal 25 is supplied to limiter 30. This limits the actuating signal and supplies it to valve controller 16. Thus, the maximum opening of valve 10 is limited once the pressure threshold value is reached. When the workpiece material finally breaks off and the tool passes through at the lower surface of the workpiece facing away from differential cylinder 1, then valve 10 is able to close very quickly when reaching the lower reversal point. This effectively prevents or at least greatly reduces an overshooting of piston 7 or of the tool at the lower reversal point.

Once the workpiece material has broken off, the pressure applied in pressure chamber 2 has dropped again below the threshold value. Consequently, the signal switch is again in the position in which actuating signal 25 is supplied directly to valve controller 16. In a subsequent upward movement and a new downward movement, the unlimited valve opening is potentially available until the tool touches down again on the workpiece. Such stroke movements at a small load may thus be performed at high speed.

It is practical to define the value to which the opening of the valve is limited in such a way as to ensure a reliable stopping of the tool at the lower reversal point within the deviation admissible for the respective nibbling machine. For this purpose, one may consider in particular the time response of the valve when closing from an activated position, the additional fixed time constants of the control loop and the stopping distance still available after the workpiece material has broken off. A limitation of the valve opening to low values, e.g. to below 20% of the maximum valve opening, ensures a precise approach of the specified reversal point.

The maximum attainable speed of the tool is of course restricted by the limitation of the valve opening. This does not increase the machining period, however, since the tool speed is potentially restricted only during the penetration of the workpiece. The maximum possible speed is in any event not attained when the workpiece is penetrated due to the load in the cutting process. Overall, time is saved due to the reduction of an overshooting movement.

### LIST OF REFERENCE NUMERALS

1 differential cylinder
2 pressure chamber on the side opposite of the piston rod
3 pressure chamber on the side of the piston rod
4 piston rod
5 reservoir
6 workpiece
7 piston
8 pressure line
10 valve
11 hydraulic pump
12 pressure line
14 accumulator
15 displacement sensor
16 valve controller
20 control electronics
21 actual value input
22 setpoint value input
24 pressure sensor
25 actuating signal
26 threshold stage
28 signal switch
30 signal limiter

What is claimed is:

1. A hydraulic drive for a nibbling machine, comprising:
a hydraulic motor;
a position sensor which detects an actual value of a position of the hydraulic motor;
a valve which allows for a pressure medium path between the motor and a pressure medium source to be controlled; and
control electronics which receive a position setpoint value signal and the actual value of the position of the motor and triggers the valve via an actuating signal to control the position of the motor;
wherein an event occurring prior to the hydraulic motor reaching a specified position is detected, and the actuating signal is limited as a function of detecting the event.

2. The hydraulic drive as recited in claim 1, further comprising:
a pressure sensor configured to measure a pressure of the pressure medium applied to the motor, the actuating signal being limited as a function of the measured pressure.

3. The hydraulic drive as recited in claim 2, wherein the control electronics comprises a comparator circuit which compares the measured pressure with a specified pressure threshold value, and the actuating signal is limited if the measured pressure exceeds the pressure threshold value.

4. The hydraulic drive as recited in claim 1, further comprising:
a force sensor which detects one of a force acting on the motor or a force exerted by the motor on a machine element;
wherein the actuating signal is limited as a function of the detected force.

5. The hydraulic drive as recited in claim 1, further comprising:
an electrical switching element configured to detect the event.

6. The hydraulic drive as recited in claim 1, wherein the control electronics comprises a signal limiter by which the actuating signal supplied to the valve may be limited to a value that corresponds to a valve opening of less than 20% of a maximum valve opening.

7. The hydraulic drive as recited in claim 1, wherein the motor is in a form of a hydraulic cylinder, the hydraulic cylinder being capable of operating a cutting tool, and the limitation of the actuating signal being triggered by the cutting tool contacting a workpiece prior to breaking through the workpiece.
